(19) United States
(12) Patent Application Publication
(10) Pub. No.: US 2022/0314403 A1
(43) Pub. Date: Oct. 6, 2022

(54) Rotational Adjustment Device

(71) Applicant: Michael A. Miotke, Dearborn Heights, MI (US)

(72) Inventor: Michael A. Miotke, Dearborn Heights, MI (US)

(21) Appl. No.: 17/713,528

(22) Filed: Apr. 5, 2022

Related U.S. Application Data
(60) Provisional application No. 63/171,278, filed on Apr. 6, 2021.

(51) Int. Cl. B25B 13/48; B25B 13/46; B60G 17/02

(52) U.S. Cl. CPC B25B 13/481; B25B 13/463; B60G 17/021

(57) ABSTRACT

A rotational adjustment device comprising: a handle; a gripping apparatus connected to and extending from the handle; a rachet assembly located within the gripping apparatus and configured to rotate a portion of the gripping apparatus; a pivot apparatus configured to allow movement of the gripping apparatus between an open position and a closed position so that when in the open position, the gripping apparatus is extendable around a feature of interest; and a locking apparatus that releasably locks the gripping apparatus in the closed position.

### CROSS-REFERENCE TO RELATED APPLICATIONS

This application claims priority U.S. Provisional Application Ser. No. 63/171,278, filed Apr. 6, 2021. The entire disclosure of which is hereby incorporated by reference.

### TECHNICAL FIELD

The present disclosure relates to a rotational adjustment device that is configured to attach to and rotationally adjust components or fasteners that are axially constrained and confined at both ends, and more specifically, a rotational adjustment device that is capable of attaching to and adjusting a coil spring of an automobile shock absorber system so that a pressure of each coil may be set to a predetermined amount.

### BACKGROUND

Attempts have been made to design tools that can rotate a fastener such as a nut, bolt, or other rotational member when attachment of the tool cannot be made from a top or bottom of the fastener. Examples of these fasteners are found under sinks, on automotive shocks, on automotive coil over shocks, or similar devices. Because access is not available from a top or bottom of the fastener, the rotational adjustment devices available can only contact a portion of the fastener. Since only a portion of the fastener is contacted, slippage of the rotational adjustment device relative to the fastener may occur. Furthermore, due to the difficulty in accessing the fastener, it may be difficult to align the rotational adjustment device to the fastener and apply torque to the fastener. Consequently, the process of rotatably adjusting the fastener may be time consuming and may lead to injuries if the rotational adjustment device slips, and the user's hands contact the surrounding structures.

In one specific example, some automotive shocks have a spring or coil locked over a cylindrical shock absorber body (i.e., a coil over shock absorber). A top or bottom of the coil or spring is fixed while the opposite end (usually the top end) is axially movable by adjusting a fastener. By axially moving the fastener to compress or decompress the coil or shock, the amount of pressure applied at each corner of the vehicle may be varied, and the suspension of the vehicle tuned. However, the fastener is located within a small, confined area, and thus, reaching and adjusting the fastener can be difficult and time consuming thereby requiring several iterations before the fastener is moved into a desired position.

It would be desirable to provide a rotational adjustment device that is capable of attaching to a fastener that is axially restrained within a confined area. A rotational adjustment device is needed that is connectable to a fastener and can rotationally adjust the fastener without removal. Furthermore, a rotational adjustment device is needed that contacts over 300 degrees of the fastener in order to rotationally adjust the fastener. It would also be desirable to provide a rotational adjustment device that may be opened and locked about the fastener. What is further needed is a rotational adjustment device that rotates a fastener of a coil over shock absorber without removing and replacing the rotational adjustment device during use.

### SUMMARY

The present disclosure provides a rotational adjustment device. The rotational adjustment device includes a handle, and a gripping apparatus connected to and extending from the handle. The rotational adjustment device includes a rachet assembly located within the gripping apparatus and configured to rotate a portion of the gripping apparatus. The rotational adjustment device includes a pivot apparatus configured to allow the gripping apparatus to move between an open position and a closed position so that when in the open position, the gripping apparatus is extendable around a feature of interest. The rotational adjustment device includes a locking apparatus that releasably locks the gripping apparatus in the closed position

The present disclosure provides a rotational adjustment device that is capable of attaching to a fastener that is axially restrained. The present disclosure provides a rotational adjustment device that is connectable to a fastener and can rotationally adjust the fastener without removal. The present disclosure provides a rotational adjustment device that contacts over 300 degrees of the fastener in order to rotationally adjust the fastener. The present disclosure provides a rotational adjustment device that is may be opened and locked about the fastener. The present disclosure provides a rotational adjustment device that moves a fastener of a coil over shock absorber without removing and replacing the rotational adjustment device during use.

### BRIEF DESCRIPTION OF THE DRAWINGS

The present disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is an isometric view of a rotational adjustment device in a closed position;

FIG. 2 is an isometric view of a rotational adjustment device in an open position;

FIG. 3 is a close-up view of the gripping apparatus including a pivot apparatus and a locking apparatus;

FIG. 4 is a partially exploded perspective view of the gripping apparatus of the rotational adjustment device with the gripping members removed;

FIG. 5 is a rear perspective view of the rotational adjustment device in an open position;

FIG. 6 is a partial cut-away view of the griping apparatus;

FIG. 7 is a partial cut away view of the griping apparatus and locking apparatus.

### DETAILED DESCRIPTION

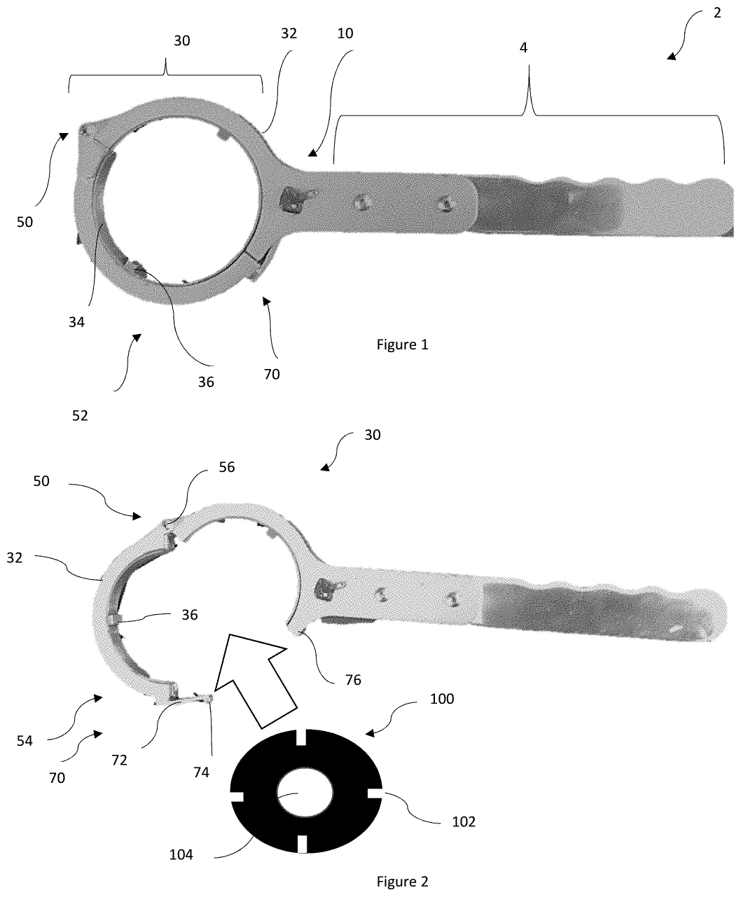

With reference to FIGS. 1-7, the present disclosure provides a rotational adjustment device 2 for engaging and rotatably adjusting a fastener 100. As shown in FIG. 1 the rotational adjustment device 2 includes a handle 4 connected to a gripping apparatus 30, wherein the handle 4 may have a fixed length or an adjustable length. The handle 4 may further include finger indentations to assist in gripping the handle 4. The gripping apparatus 30 has a substantially circular housing 32 that houses gripping members 34 with gripping teeth 36. The housing 32 of the gripping apparatus 30 comprises a movement arm 40 and a holding arm 42 that are pivotally connected at a pivot apparatus 50 to allow movement between an open position 55 (see FIG. 2) and a closed position 52 (see FIG. 1). The gripping apparatus 30 is movable about the pivot apparatus 50 so that the gripping apparatus 30, specifically the gripping members 34 and the gripping teeth 36, may engage a feature of interest, such as the fastener 100 or a nut. The number, shape, size, position, or a combination thereof of the gripping teeth 36 may vary depending upon the fastener 100 being rotationally adjusted. Each of the gripping members 34 may be designed for a specific fastener 100, or the gripping members 34 may be generic for all fasteners 100. The gripping apparatus 30 may be generally circular, oval, triangular, pentagonal, pentagonal, heptagonal, hexagonal, octagonal, nonagonal, or a combination thereof. The gripping apparatus 30 may have an inner periphery that extends around the fastener 100 a distance of approximately 300 to 360 degrees. The gripping apparatus 30 may form a closed structure that fully surrounds the fastener 100 in the closed position and an open structure that receives the fastener 100 in the open position. A thickness of the gripping member 34 may vary to change an inner area or inner circumference of the gripping apparatus 30. For example, the gripping member 34 may have a first thickness (e.g., a distance from an inner wall and an outer wall) to grip a fastener that is 5 cm in size and a second thickness to grip a fastener that is 7 cm in thickness. The rotational adjustment device 2 may rotationally adjust any fastener 100 that may be rotationally tightened or loosened. The fastener 100 may be part of a vehicle shock, wherein the fastener 100 may compress a spring. The fastener 100 may be part of a sink or a drain, or the fastener 100 may be located along an elongated member where the fastener 100 is only accessible from a side of the elongated member. The fastener 100 may not be accessible from a location above or below the fastener 100 due to the elongated member (e.g., threaded member) extending through the fastener 100.

FIGS. 1 and 2 illustrate the gripping apparatus 30 in the closed position 52 and the open position 54, respectively, wherein the gripping apparatus 30 may move between the open position 54 and the closed position 52 by pivoting the movement arm 40 relative to the holding arm 42 of the housing 32 about a pivot pin 56 in the pivot apparatus 50. In the open position 54, a locking apparatus 70 is exposed and may include a tongue 72 that extends outward from a free end of the movement arm 40 of the gripping apparatus 30, wherein the tongue 72 is extendable into a recess 76 of the holding arm 42. A lip 74 extends outward from the tongue 72 and catches a wall of or latch in the recess 76 in the holding arm 42. The pivot apparatus 50 functions to allow the housing 32 of the gripping apparatus 30 to move between the open position 54 and the closed position 52. The pivot apparatus 50 allows the movement arm 40 and the holding arm 42 to pivot with respect to one another about the pivot pin 56, as shown, or may be free of the pivot pin 56 to utilize an alternative structure, such as a living hinge. The pivot apparatus 50 may allow the movement arm 40 of the housing 32 to pivot about 90 degrees or more, about 120 degrees or more, about 135 degrees or more, about 160 degrees or more, or about 180 degrees or more relative to the holding arm 42 of the housing 32. The pivot apparatus 50 may also allow the movement arm 40 of the housing 32 to pivot about 270 degrees or less, 225 degrees or less, or 180 degrees or less relative to the holding arm 42.

In order to rotatably adjust the fastener 100, the gripping apparatus 30 may engage the fastener 100, as shown in FIG. 2. The fastener 100 shown is from a conventional coil over shock assembly, but the disclosure is not limited to a fastener 100 from a conventional coil over shock assembly, but rather, the fastener 100 may comprise any fastener which may benefit from the rotational adjustment of the rotational adjustment device 2. The fastener 100 comprises a cylindrical disk that may include four open-ended, equally spaced, substantially rectangular fastener recesses 102, although it should be noted that the disclosure is not limited to four fastener recesses 102, but rather, the fastener 100 may have any number of fastener recesses 102. The fastener recesses 102 are complementarily received by the gripping teeth 36 of the gripping apparatus 30 in the closed position 52 so that the gripping apparatus 30 can engage the fastener 100 in the closed position 52 and rotate the fastener 100 about a rotational axis. The fastener 100 may further include a fastener aperture 104 that extends axially through the fastener 100 and may receive a threaded member (not shown) from a coil over shock assembly (not shown). The fastener 100 may be rotated about the threaded member of the coil over shock assembly such that the fastener 100 moves axially along the threaded member to adjust the axial length of the coil in the coil over shock assembly. As illustrated, the gripping apparatus 30 is moved to the open position 54 by pivoting the movement arm 40 about the pivot apparatus 50 and away from the holding arm 42 so that the fastener 100 may be received within the gripping apparatus 30 from a side of the fastener 100. This allows the rotatably adjusting device 2 to engage the fastener 100 from the side of the fastener 100 when the fastener 100 is inaccessible from above and below the fastener 100.

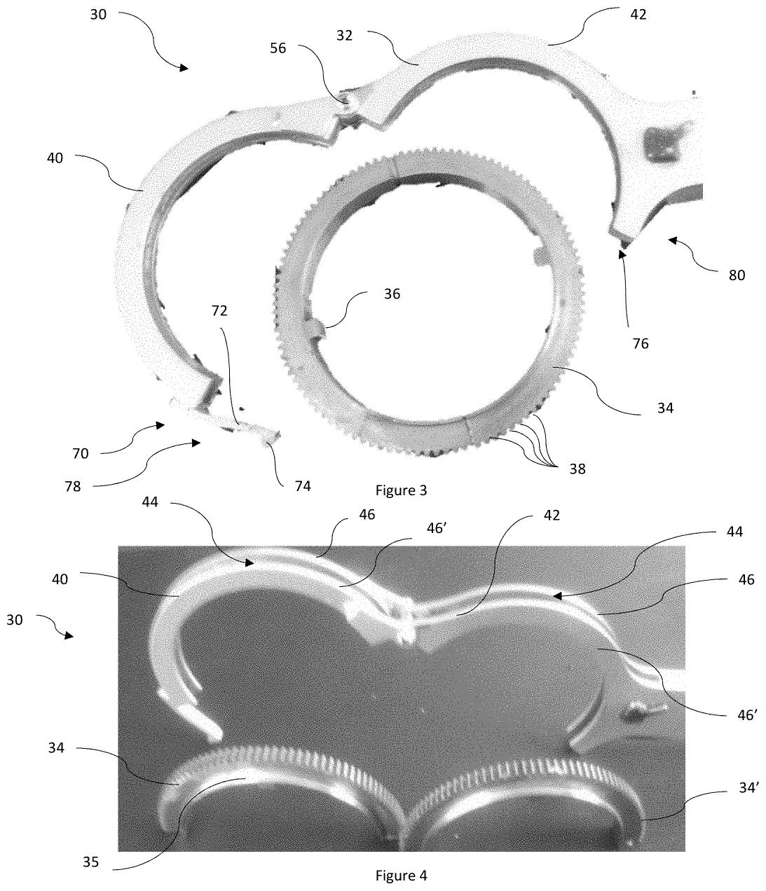

To move and lock the gripping apparatus 30 between the open position 54 and the closed position 52, one end of the movement arm 40 may be moved apart from one end of the holding arm 42 of the gripping apparatus 30 by pivoting the movement arm 40 about the pivot pin 56, as shown in FIG. 3. The movement arm 40 and the holding arm 43 each have semi-circular configurations so that the movement arm 40 and the holding arm 43 form a substantially circular configuration when in the closed position 52. The movement arm 40 includes a first portion 78 of the locking apparatus 70, which includes the tongue 72 and the lip 74. The holding arm 42 includes a second portion 80 of the locking apparatus 70, which includes a recess 76 in one end of the holding arm 42. The recess 76 may receive the tongue 72, the lip 74, or both. The lip 74 may engage a wall or latch within the recess 76 to lock the movement arm 40 to the holding arm 42 in the closed position.

In order to grip the fastener 100 and provide ratcheting of the rotatably adjusting device 2, two of the gripping members 34 are removably received by the gripping apparatus 30. Each of the gripping members 34 have a semi-circular configuration, and when housed within the gripping apparatus 30, the gripping members 34 align to form a substantially circular configuration when in the closed position 52. The gripping members 34 include gripping teeth 36 that extend radially inward from the inner periphery of the gripping members 34 to complementarily engage the fastener recesses 102 in the fastener 100. The gripping members 34 also provide rotary teeth 38 that extend radially outward from the outer periphery of the gripping members 34 in a direction opposite the gripping teeth 36. The rotary teeth 38 may be sized and shaped to rotate the gripping member 34, create a ratchet, remove torque from the fastener, apply torque to the fastener 100 in communication with a gripping member 34, or a combination thereof. The gripping members 34 may each include about 10 or more, about 20 or more, about 30 or more, or about 35 or more rotary teeth 38. The gripping members 34 may each include about 100 or less, about 75 or less, or about 50 or less rotary teeth 38. The rotary teeth 38 may be located opposite the gripping teeth 36. A number of gripping teeth 36 may vary depending on the type of fastener 100 being rotatably adjusted. The gripping members 34 may each include 0 or more, 1 or more, 2 or more, 3 or more, 4 or more, or 5 or more gripping teeth 36. The gripping members 34 may each include 20 or less, 15 or less, 10 or less, or 7 or less gripping teeth 36. The gripping teeth 36 may have a shape that is triangular, rounded, arcuate, square, square with rounded corners, rectangular, semicircular, trapeze, a parallelogram, or a combination thereof. The gripping teeth 36 function to engage the fastener 100 so that the gripping teeth 36 may rotatably move the fastener 100.

FIG. 4 is a rear perspective view of the gripping apparatus 30 with the gripping members 34 removed from the gripping apparatus 30. The movement arm 40 and the holding arm 42 of the gripping apparatus 30 each have an arm recess 44. The arm recess 44 extends through the movement arm 40 and the holding arm 42 and is defined between similar semi-circular, opposite walls 46, 46′ of the movement arm 40 and the holding arm 42. Each arm recess 44 receives one of the gripping members 34 in a manner that allows the gripper members 34 to rotate within the arm recesses 44. The arm recesses 44 may decrease friction relative to the gripping members 34, as the gripping members 34 rotate within the gripping apparatus 30. The gripping apparatus 30 may include a low friction coating such as polytetrafluoroethylene (PTFE) (i.e., Teflon), be anodized, plastic, poly, or a combination thereof. The gripping apparatus 30 may have a polymeric material that contacts the gripping member 34 so that wear is reduced or eliminated between the movement arm 40, the holding arm 42, and the gripping members 34. The gripping members 34 have a first gripping member 34 that is received by the movement arm 40 and a second gripping member 34′ that is received by the holding arm 42. Each gripping member 34, 34′ includes a shoulder 35 that extends axially from the gripping members 34. The shoulder 35 may be located on a first side, a second side, or both in an axial direction relative to a rotational axis of the gripping apparatus 30. The shoulder 35 engages an inner periphery wall of the movement arm 40 and the holding arm 42 to hold and position the gripping members 34 within the movement arm 40 and the holding arm 42.

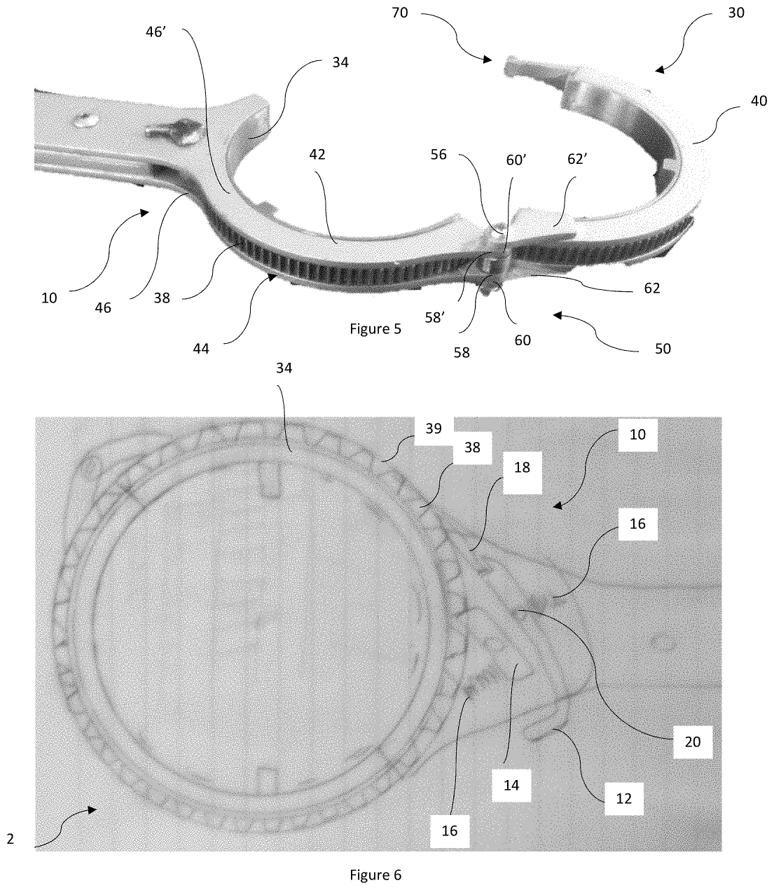

FIG. 5 is a rear perspective view showing the pivot apparatus 50 of the gripping apparatus 30. The pivot apparatus 50 includes a pivot pin 56 that extends through pivot members 58 of the movement arm 40 and the holding arm 42 of the gripping apparatus 30. The movement arm 40 and the holding arm 42 may include one pivot member 58 or two pivot members 58. The pivot members 58 may be alternatively located relative to one another. As shown, the pivot members 58 of the holding arm 42 are formed by an extending portion 60, 60′ of the opposing walls 46, 46′ of the holding arm 42 wherein coaxial apertures (not shown) extend through the extending portions 60, 60′ of the opposing walls 46, 46′ of the holding arm 42. The pivot members 58 of the movement arm 40 have a pair of extending flanges 62, 62′ that are connected to and extend from the opposing walls 46, 46′ of the movement arm 40. The extending flanges 62, 62′ each have an aperture (not shown) that extend coaxially through the extending flanges 62, 62′. The extending flanges 62, 62′ of the movement arm 40 overlap the extending portions 60, 62 of the holding arm 42 respectively such that the apertures in the extending portions 60, 60′ and the flanges 62, 62′ contact one or more of the rotary teeth 38 by extending into the rotary recess 39. As shown, the pawl 14 and the lever 12 may rotate about a pivot; however, the pawl 14 or the lever 12 may move linearly (e.g., in a straight line) or may move within or along a track. The pawl 14 or the lever 12 may be biased by one or more biasing members 16, wherein the biasing members 16 may be a spring, an elastomeric material, a rubber, an expandable material, a compressible material, a cantilever spring, or a helical spring. The pawl 14 or lever 12 may be placed in compression, tension, or a combination thereof.

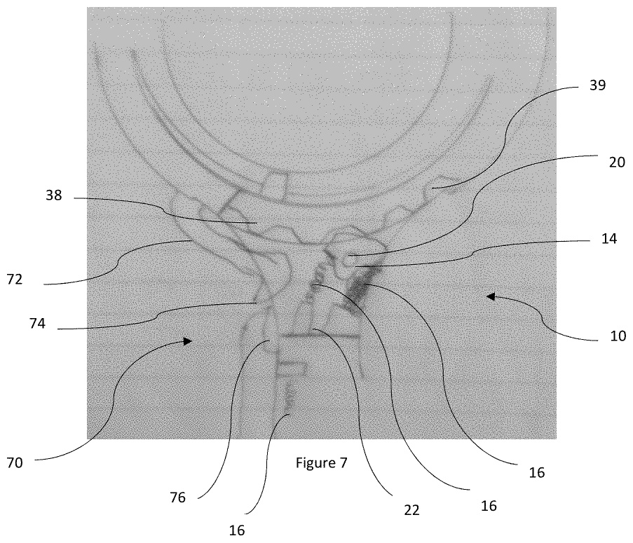

FIG. 7 illustrates a rachet assembly 10 and a locking assembly 70 of the rotatably adjustment device 2. The rachet assembly 10 includes a pawl 14 that is pivotally connected to the handle 4 by the lever pivot or pivot pin 20. The pawl 14 is rotatable about the lever pivot 20 to determine a direction of rotation. The pawl 14 includes a biasing member 16 on each side of the pawl 14 to allow the pawl 14 to pivot and move out of the way of the rotary teeth 38 as the rotary teeth 38 move past the pawl 14 and act to bias the pawl 14 into a rotary recess 39. The locking apparatus 70 has a tongue 72 with a lip 74 that extends into a recess 76 formed within the handle 4 to form a locked connection so that the gripping apparatus 30 is prevented from moving toward the open position.

In operation, the rotational adjustment device 2 may be utilized to rotationally adjust a fastener 100 that may be constrained from a location from above or below the fastener 100. To engage the fastener 100 with the rotational adjustment device 2, the free end of the movement arm 40 is pivoted away from the holding arm 42 toward the open position. The movement arm 40 and the holding arm 42 are wrapped around the fastener 100 such that the gripping teeth 36 engage the fastener 100. The free end of the movement arm 40 is pivoted toward and into the recess 76 of the holding arm 42, and the locking apparatus 70 locks the movement arm 40 to the holding arm 42 to establish the closed position 52. The rotational adjustment device 2 may utilize the ratchet assembly 10 to rotate the fastener 100 in a first direction or a second direction or correspondingly, to tighten or loosen the fastener 100. Once the rotational adjustment is complete, the locking apparatus 70 may release the movement arm 40 from the holding arm 42 so that the free end of the movement arm 40 may pivot away from the holding arm 42 thereby allowing the movement arm 40 and the holding arm 42 to be removed from the fastener 100

Variation 1 may comprise a rotational adjustment device comprising: a handle; a gripping apparatus connected to and extending from the handle; a rachet assembly located within the gripping apparatus and being configured to rotate a portion of the gripping apparatus; a pivot apparatus configured to move the gripping apparatus between an open position and a closed position so that when in the open position the gripping apparatus is extendable around a feature of interest; and a locking apparatus that releasably locks the gripping apparatus in the closed position

Variation 2 may comprise the rotational adjustment device of variation 1, wherein the gripping apparatus comprises a plurality of gripping members.

Variation 3 may comprise the rotational adjustment device of variation 1 or 2, wherein the plurality of gripping members are two gripping members.

Variation 4 may comprise the rotational adjustment device of any of the preceding variations, wherein the gripping members are removable so that a different set of gripping members are insertable into the gripping apparatus.

Variation 5 may comprise the rotational adjustment device of variation 2 or any of the preceding variations, wherein the plurality of gripping members have a shoulder that prevents the gripping members from axially moving relative to the gripping apparatus of the rotational adjustment device.

Variation 6 may comprise the rotational adjustment device of variation 2 or any of the preceding variations, wherein the plurality of gripping member have a gripping tooth located within an inner periphery (e.g., circumference) of the gripping members.

Variation 7 may comprise the rotational adjustment device of variation 2 or any of the preceding variations, wherein the plurality of gripping members include rotary teeth around an outer periphery (e.g., circumference) of the gripping members.

Variation 8 may comprise the rotational adjustment device of any of the preceding variations, wherein the gripping apparatus include a movement arm and a holding arm that are connected by the pivot apparatus.

Variation 9 may comprise the rotational adjustment device of variation 8 or any of the preceding variations, wherein the movement arm, the holding arm, or both include arm recesses that are configured to accept gripping members.

Variation 10 may comprise the rotational adjustment device of variation 8 or any of the preceding variations, wherein the movement arm is pivotable about the pivot apparatus between the open position and the closed position so that when in the open position the gripping apparatus receives the feature of interest.

Variation 11 may comprise the rotational adjustment device of any of the preceding variations, wherein the pivot apparatus includes a pivot pin that extends through pivot members of the gripping apparatus so that all or a portion of the gripping apparatus is rotatable about the pivot pin.

Variation 12 may comprise the rotational adjustment device of any of the preceding variations, wherein the locking apparatus includes a tongue that extends into a recess so that the gripping apparatus is openable and closable.

Variation 13 may comprise the rotational adjustment device of variation 12 or any of the preceding variations, wherein the tongue includes a lip that catches a wall of the recess to lock the locking apparatus.

Variation 14 may comprise the rotational adjustment device of variation 12 or any of the preceding variations, wherein the tongue is depressible to release the recess.

Variation 15 may comprise the rotational adjustment device of any of the preceding variations, wherein the ratchet assembly includes a lever that switches the ratches assembly between a clockwise rotation and a counterclockwise rotation.

Variation 16 may comprise the rotational adjustment device of variation 15 or any of the preceding variations, wherein the ratchet assembly includes a pawl that is extendable into rotary teeth of a gripping member within the gripping apparatus so that the gripping member is stopped, braked, locked, rotatable only in a first direction, rotatable only in a second direction, or a combination thereof.

Variation 17 may comprise the rotational adjustment device of any of the preceding variations, wherein the rachet assembly includes a pawl that is biased between a first position (e.g., clockwise), a second position (e.g., counterclockwise), a third position (e.g., locked), or a combination thereof by a bias member, a lever, or both.

Variation 18 may comprise the rotational adjustment device of any of the preceding variations, wherein the rotational adjustment device is configured to connect to a fastener of a coil over shock assembly and to adjust a compression of the coil by axially moving the fastener.

While the disclosure has been made in connection with what is presently considered to be the most practical and preferred embodiment, it should be understood that the disclosure is intended to cover various modifications and equivalent arrangements.

What is claimed is:

1. A rotational adjustment device comprising:
a handle;
a gripping apparatus connected to and extending from the handle;
a rachet assembly located within the gripping apparatus and being configured to rotate a portion of the gripping apparatus;
a pivot apparatus configured to move the gripping apparatus between an open position and a closed position so that when in the open position the gripping apparatus is extendable around a feature of interest; and
a locking apparatus that releasably locks the gripping apparatus in the closed position.

2. The rotational adjustment device of claim 1, wherein the gripping apparatus comprises a plurality of gripping members.

3. The rotational adjustment device of claim 1, wherein the plurality of gripping members are two gripping members.

4. The rotational adjustment device of claim 1, wherein the gripping members are removable so that a different set of gripping members are insertable into the gripping apparatus.

5. The rotational adjustment device of claim 2, wherein the plurality of gripping members have a shoulder that prevents the gripping members from axially moving relative to the gripping apparatus of the rotational adjustment device.

6. The rotational adjustment device of claim 2, wherein the plurality of gripping member have a gripping tooth located within an inner periphery of the gripping members.

7. The rotational adjustment device of claim 2, wherein the plurality of gripping members include rotary teeth around an outer periphery of the gripping members.

8. The rotational adjustment device of claim 1, wherein the gripping apparatus include a movement arm and a holding arm that are connected by the pivot apparatus.

9. The rotational adjustment device of claim 8, wherein the movement arm, the holding arm, or both include arm recesses that are configured to accept gripping members.

10. The rotational adjustment device of claim 8, wherein the movement arm is pivotable about the pivot apparatus between the open position and the closed position so that when in the open position the gripping apparatus receives the feature of interest.

11. The rotational adjustment device of claim 1, wherein the pivot apparatus includes a pivot pin that extends through pivot members of the gripping apparatus so that all or a portion of the gripping apparatus is rotatable about the pivot pin.

12. The rotational adjustment device of claim 1, wherein the locking apparatus includes a tongue that extends into a recess so that the gripping apparatus is openable and closable.

13. The rotational adjustment device of claim 12, wherein the tongue includes a lip that catches a wall of the recess to lock the locking apparatus.

14. The rotational adjustment device of claim 12, wherein the tongue is depressible to release the recess.

15. The rotational adjustment device of claim 1, wherein the ratchet assembly includes a lever that switches the ratches assembly between a clockwise rotation and a counterclockwise rotation.

16. The rotational adjustment device of claim 15, wherein the ratchet assembly includes a pawl that is extendable into rotary teeth of a gripping member within the gripping apparatus so that the gripping member is stopped, braked, locked, rotatable only in a first direction, rotatable only in a second direction, or a combination thereof.

17. The rotational adjustment device of claim 1, wherein the rachet assembly includes a pawl that is biased between a first position, a second position, a third position, or a combination thereof by a bias member, a lever, or both.

18. The rotational adjustment device of claim 1, wherein the rotational adjustment device is configured to connect to a fastener of a coil over shock assembly and to adjust a compression of the coil by axially moving the fastener.

19. The rotational adjustment device of claim 10, wherein the pivot apparatus includes a pivot pin that extends through pivot members of the gripping apparatus so that all or a portion of the gripping apparatus is rotatable about the pivot pin.

20. The rotational adjustment device of claim 19, wherein the locking apparatus includes a tongue that extends into a recess so that the gripping apparatus is openable and closable.
